(19) United States
(12) Patent Application Publication
(10) Pub. No.: US 2012/0314527 A1
(43) Pub. Date: Dec. 13, 2012

(54) STIRRER FOR ALL TYPES OF CONTAINERS, AND ESPECIALLY FOR A BABY BOTTLE

(75) Inventor: Jean-Paul VULLIERMET, Agde (FR)

(73) Assignee: Beaba, Paris (FR)

(21) Appl. No.: 13/491,684

(22) Filed: Jun. 8, 2012

(30) Foreign Application Priority Data
Jun. 8, 2011 (FR) 1101748

(51) Int. Cl. B01F 13/00

(52) U.S. Cl. 366/129

(57) ABSTRACT

A mixer for a container, the mixer including a gripping portion, a motor integrated into the gripping portion, a rotary shaft driven by the motor, and a mixing element having a flexible body. The mixing element has a first flexible body portion having a first end and a second flexible body portion having a second end, the first end and the second end being connected to the rotary shaft.

### CROSS-REFERENCE TO RELATED APPLICATIONS

The present application claims priority under 35 U.S.C. §119 to French Patent Application No. 1101748 (filed on Jun. 8, 2011), which is hereby incorporated by reference in its entirety.

### FIELD OF THE INVENTION

The present disclosure relates to the field of stirrers, especially for homogenizing a mixture of a powder and of a liquid. It more specifically aims at reconstituting infant milk, and thus at the stirring in a baby bottle.

### BACKGROUND OF THE INVENTION

Stirrers for baby bottles are widely known. Conventionally, such stirrers are electric and comprise an actual rotatable stirring element intended to be introduced into the bottle, which is associated with a rotary axis and rotated by an electric motor, most often integrated in an area playing the role of a gripping portion of the stirrer.

In a known embodiment, such as for example described in document WO 2010/029377, the portion intended for the stirring is formed of an axis having a loop, especially made of a deformable material, arranged at its end.

Such stirrers are not fully satisfactory due, on the one hand, to the fact that they are not adaptable to all types of containers, and especially to all types of baby bottles, and, on the other hand, to the fact that the resulting stirring is not optimal.

### SUMMARY OF THE INVENTION

Thus, the present invention first aims at optimizing the quality of the stirring, for accordingly improving the homogenizing of a powder—liquid mixture. It also aims at forming a stirrer adaptable to all sizes of container necks, and especially of baby bottle necks, and this in terms of height as well as of opening diameters.

For this purpose, it aims at a new stirrer for a container, and especially for a baby bottle, comprising a first gripping portion integrating an electric motor actuating a rotary axis or shaft, and possibly the batteries necessary for its operation, and a stirring element formed of a flexible element, and for example, of a loop having its ends directly or indirectly connected to the rotary shaft of said motor.

In other words, the present invention aims at providing, as a stirring element, an element made of a flexible material, to be able to easily penetrate into any type of container, and capable of generating, when the electric motor having said element connected to its rotary shaft is running, a vortex promoting the stirring, and thus optimizing the homogeneity of a suspension. Such an element is for example formed of a loop.

Further, whether the length of the loop is greater than the container size, and especially to the height of the baby bottle, matters little, precisely due to its flexibility. Under such an assumption, although the loop will partly lie on the bottom of the container, it however generates said vortex when it is submitted to the rotation under the action of the electric motor, although simultaneously touching the edges and/or the bottom of the container.

It can thus be understood that the stirrer of the present invention is capable of being implemented whatever the size, and especially the height, of the container.

Further, the gripping portion or area advantageously has a flared lower area capable of bearing against the upper end of the container neck. Thereby, by providing to give such a flared area a sufficient height and, accordingly, to have a wide range of variability of the diameter of the area, the stirrer of the present invention is capable of adapting to any other type of container neck diameter, and thus of baby bottle neck diameter.

Further, and advantageously, the gripping area is coated with a flexible elastomeric material extending on top of the flared area of said lower end. This enables to optimize the device gripping. It may further be provided for this coating to be continued all the way to said flared end. This then enables to optimize the tightness.

Thus, the stirrer of the present invention can be used for a very large number of containers while keeping its optimized stirring properties, which was not possible with prior art devices, either due to the uniqueness of the diameter of the container to which it is likely to be adapted, or due to the actual stirring element, most often formed of a rigid axis having a determined size, and especially a determined length.

According to the present invention, almost only the flexible loop is capable of penetrating into the volume defined by the container. One then no longer depends, in a way or another, on a rigid rotary axis such as conventionally equipping prior art stirrers. A sufficiently long loop just has to be provided in order to be usable in most containers, and especially in most baby bottles available for sale.

Thereby, the rotary axis of the motor may indeed penetrate into the container, but in very limited fashion at the level of the container neck. Further, a rotary axis is capable of adapting and especially of reversibly fastening, for example, by fitting on the rotary drive shaft, the two ends of the flexible loop then being positively connected to this axis. Advantageously, the assembly formed by the rotary axis and the loop can then be detached to facilitate their cleaning after use, including by means of a dishwasher.

To further improve the efficiency of the stirring operation, the flexible loop preferably has an oblong shape.

According to a variation of the present invention, the flexible loop is opened (and thus non-continuous) at its distal end, thus defining two strands, the latter being however interconnected by a connection element. Thereby, a beater is formed which has a smaller width than the diameter of the container neck, and especially of the baby bottle neck, thus enabling to more easily introduce the stirrer into said container, especially with one hand, and therefore, to decrease the contamination of the flexible loop by the user during its installation.

Advantageously, the two strands of the flexible loop thus opened are interconnected substantially at half their length. The loop is then given a greater resistance and its deformation is decreased during its rotation in the liquid to be stirred, thus enabling to further improve the efficiency of the stirring operation.

Other embodiments of the flexible loop may be envisaged while remaining within the spirit and scope of the present invention, and especially the use of a continuous closed loop.

### BRIEF DESCRIPTION OF THE DRAWINGS

The foregoing and other features and advantages of the present invention will be discussed in detail in the following non-limiting description of specific embodiments in connection with accompanying drawings.

FIG. 1 is a simplified perspective view of the baby bottle stirrer according to the present invention, inserted in a baby bottle.

FIG. 2 is a simplified representation of the baby bottle stirrer in front view, shown outside of the bottle.

### DETAILED DESCRIPTION OF EMBODIMENTS

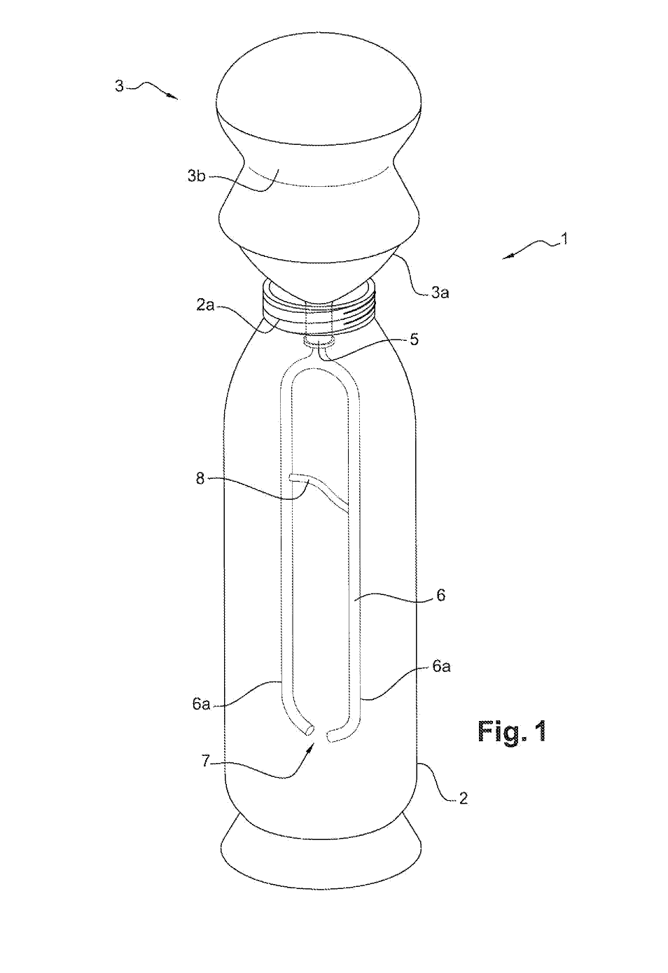

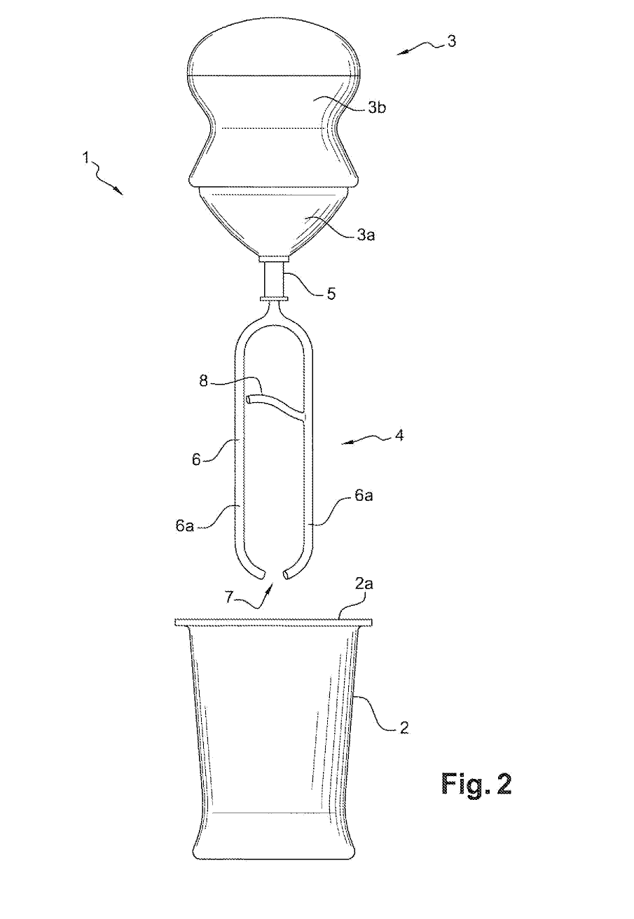

Referring to FIGS. 1 and 2, the stirrer (1) for a baby bottle (2) comprises a gripping portion (3). Said portion integrates an electric motor (not shown) actuating a rotary shaft (not shown). It also comprises batteries (not shown either) for electrically powering the motor.

In the embodiment described in relation with FIGS. 1 and 2, a rotary axis (5) is assembled by fitting on the drive shaft. It can thus be very easily detached from it, especially for washing purposes.

The stirrer (1) further comprises a second portion (4) defining the actual stirring element. Said element is basically formed of a flexible loop (6), having its two ends attached, for example, by gluing, on the rotary axis (5). The rotary axis (5) is rigid, even though, as already mentioned, the loop (6) is flexible. The latter is for example made of silicon. However, another food-compatible elastomer may be used.

The hardness (actually defining the flexibility) of the material used for example ranges between 40 and 80 ShA (Shore A).

Further, the diameter of the strand(s) (6a) forming the loop ranges between 2 and 5 millimeters.

According to a preferred embodiment of the present invention, the gripping portion (3) has an ergonomic shape, in particular, rounded, or again a diabolo shape. It comprises a lower flared portion (3a), intended to place itself against the open upper end of the neck (2a) of the baby bottle. This flared portion (3a) is topped with an intermediate area (3b), continued in turn by a upper rounded portion, intended to be hand-held by the user of the stirrer (1). The on/off switch of the electric motor is further arranged on this rounded portion or at the intermediate area level.

The flared portion (3a) extends from the rounded portion by its wider portion and decreases to form a cone. The drive shaft, or even the axis (5), is arranged in line with this cone. Axis (5) is inserted into this flared portion (3a) and cooperates inside of the gripping portion (3) with the electric rotary motor. The other side of the axis (5) is continued by the flexible loop (6).

According to an advantageous feature of the present invention, the intermediate area (3b) of the gripping portion (3) is coated with an elastomer layer, precisely to promote the gripping. This coating may also be continued all the way to the lower portion of the flared area (3a) for, in this case, promoting the tightness between the container and the stirrer, and thus doing away with risks of liquid projection during stirring phases.

The flexible loop (6) may be continuous and oblong. However, and as illustrated in the drawings, it may be opened at its distal end with respect to the gripping portion (3).

This opening (7) separates the loop (6) into two strands (6a). A connection element (8) in the form of a rod, advantageously formed of the same material as the loop (6), is arranged between the two strands (6a) and enables to connect them at the center of the loop (6). Thereby, the expansion of the loop is better controlled, and especially on introduction thereof into the baby bottle, and further, its size is decreased to promote said introduction.

Thus, during the use, the user holds the stirrer (1) by the gripping portion (3) and inserts the loop (6) into the baby bottle (2) containing a liquid to be stirred, or a powder+liquid suspension to be homogenized, such as an infant milk to be reconstituted.

The user inserts the loop (6) until the flared portion (3a) stops against the neck (2a) of the baby bottle (2). The tightness is then ensured by the flared shape (3a) of this portion, and possibly optimized by an adapted coating of this flared portion (see above). Loop (6) then is inside of the bottle (2) and, according to the height of the bottle, bears against the bottom thereof, or simply dangles inside of it. The axis (5) coming out of the motor substantially remains in the neck portion of the bottle (2). If the bottle (2) has a height smaller than the length of the loop (2), said loop folds on the wall of said bottle (2), such a folding being made easy by the flexibility of the loop.

The user then actuates the switch for turning on the electric motor and the loop (6) is rotated to perform the stirring operation. A vortex is then created in the liquid, whatever the loop length in the bottle, once again due to its flexibility, and the stirring is optimal.

The loop (6) being formed of a flexible material, risks of breakage thereof are non-existent, and when the loop (6) is folded on the bottle wall, the efficiency of the mixing is further increased since the strands (6a) scour said wall as the loop (6) rotates.

As appears from the foregoing, the present invention provides a stirrer (1) for a baby bottle (2), of simplified use, adaptable to all sizes of baby bottles (2), and this in terms of height as of opening diameter. The present invention especially provides a stirrer (1) performing an optimal stirring operation while providing the sufficient tightness to avoid any projection of the liquid outside of the container.

Of course, the present invention is likely to have various alterations, modifications, and improvements which will readily occur to those skilled in the art. Such alterations, modifications, and improvements are intended to be part of this disclosure, and are intended to be within the spirit and the scope of the present invention. Accordingly, the foregoing description is by way of example only and is not intended to be limiting. The present

What is claimed is:

1-9. (canceled)

10. A stirrer for a container, the stirrer comprising:
a gripping portion;
a motor integrated into the gripping portion;
a rotary shaft driven by the motor; and
a stirring element having a flexible body and including a first flexible body portion having a first end and a second flexible body portion having a second end, the first end and the second end being connected to the rotary shaft.

11. The stirrer of claim 10, wherein only the flexible loop is configured to penetrate into the volume defined by the container.

12. The stirrer of claim 10, further comprising a rotary axis connected to the rotary shaft and configured to penetrate into the container no further than a neck thereof.

13. The stirrer of claim 10, wherein the flexible body is composed of a food-compatible material.

14. The stirrer of claim 13, wherein the flexible body is composed of an elastomer.

15. The stirrer of claim 13, wherein the flexible body is composed of silicon.

16. The stirrer of claim 10, wherein the gripping portion abuts an upper end of a neck of the container.

17. The stirrer of claim 16, wherein the gripping portion comprises:
an intermediate area; and
a flared portion at a lower end thereof and configured to at least partially penetrate into the neck.

18. The stirrer of claim 17, wherein the intermediate area and the flared portion are coated with an elastomeric material.

19. The stirrer of claim 17, wherein the flared portion extends from the intermediate area.

20. The stirrer of claim 10, wherein the flexible body has an oblong cross-section.

21. The stirrer of claim 10, wherein the flexible body is opened at a distal end thereof.

22. The stirrer of claim 10, further comprising a connection element which extends between and connects the first flexible body portion and the second flexible body portion.

23. The stirrer of claim 22, wherein the connection element is composed of a same material as the flexible body.

24. A stirrer for a container, the stirrer comprising:
a gripping portion having a motor provided therein;
a rotary shaft driven by the motor;
a rotary axis connected to the rotary shaft; and
a stirring element operatively connected to the rotary axis and composed of a flexible material, the stirring element including a first stirring element portion and a second stirring element portion.

25. The stirrer of claim 24, wherein the rotary axis is configured to penetrate into the container no further than a neck thereof.

26. The stirrer of claim 24, wherein respective distal ends of the first stirring element portion and the second stirring element portion are spaced apart by an opening.

27. The stirrer of claim 24, further comprising a connection element which extends between and connects the first stirring element portion and the second stirring element portion.

28. A stirrer comprising:
a gripping portion having an intermediate area and a flared portion at a lower end thereof;
a motor integrated into the gripping portion;
a rotary shaft driven by the motor; and
a stirring element operatively connected to the rotary shaft and composed of a flexible material, the stirring element including a first stirring element portion, a second stirring element portion and a connection element which extends between and connects the first stirring element portion and the second stirring element portion.

29. The stirrer of claim 26, further comprising an opening at respective distal ends of the first stirring element portion and the second stirring element portion.
